(19) United States
(12) Patent Application Publication
(10) Pub. No.: US 2017/0219708 A1
(43) Pub. Date: Aug. 3, 2017

(54) OPTOELECTRONIC APPARATUS FOR SECURING A SOURCE OF DANGER

(71) Applicant: SICK AG, Waldkirch (DE)

(72) Inventors: Jens GEBAUER, Waldkirch (DE); Christoph HOFMANN, Waldkirch (DE); Matthias NEUBAUER, Waldkirch (DE)

(21) Appl. No.: 15/419,388

(22) Filed: Jan. 30, 2017

(30) Foreign Application Priority Data
Feb. 2, 2016 (DE) 102016101793.0

(51) Int. Cl. G01S 17/42; G01S 7/481

(52) U.S. Cl. CPC G01S 17/42; G01S 7/481

(57) ABSTRACT

An optoelectronic apparatus for securing a source of danger in a spatial zone includes at least one image sensor that works in the infrared spectrum and that can generate range-resolved data of the spatial zone as well as an evaluation unit that is configured for the evaluation of the data for the detection of objects in a three-dimensional protected space within the spatial zone, wherein the source of danger is additionally at least partly secured by a mechanical partition that is at least very largely permeable to visually visible light. To provide a solution that prevents or at least reduces disturbing optical influences from outside the partition, it is proposed that the partition is coated with a layer such that the non-coated layer that is at least partly transparent for the image sensor is visible for the image sensor in a defined manner through the layer and is opaque.

The invention relates to a optoelectronic apparatus for securing a source of danger in a spatial zone having a range resolving light receiver in accordance with the preamble of claim 1.

Optical protective devices can be used for monitoring zones or spaces as well as in particular hazardous sites. A particularly accurate monitoring is in this respect possible with 3D sensors that can be based on various methods such as stereoscopy, triangulation, time of flight, interference of passive two-dimensional patterns, evaluation of projected illumination patterns and further processes. The aim of the monitoring in each case is the recognition of a state classified as critical within a three-dimensional protected space that then results in a warning or a securing of a source of danger, for instance in the form of a safety-directed shutdown. The critical state can be an intervention or even an entering into the protected space by an operator.

Such optical protective devices mostly work in the infrared spectral range and are frequently used together with mechanical protective devices. The mechanical protective devices are partitions through which operators can still look to be able to observe the machine. The partitions therefore comprise, for example, acrylic glass or metal gratings having open mesh.

Objects with high IR remittance or with high IR absorption generally produce an overload or an underload of the sensor. The consequence in both cases is that the sensor can no longer calculate the distance from the object. Objects having overloading or underloading properties outside the protected space and disposed behind the virtual protected space from the viewpoint of the sensor therefore have to be assumed as an “infringement” of the protected space for safety reasons even though the object is not located in the protected space.

Since the infrared light of the sensor penetrates the transparent partitions to a very large part, the problem then occurs that objects outside the monitored scene, that is here the regions behind a mechanical partition, may negatively affect the sensor behavior. For example, a retroreflective high-visibility jacket of an operator or placed down material can effect an overload (dazzling) of the camera. An emergency shutdown then takes place that was actually not necessary. It can also occur that the object behind the partition absorbs the IR light and the sensor cannot “see” anything and has to switch off to preclude a disturbance.

If metal gratings are used as partitions, the following problems can cause errors: Invalid measured values/depth values can occur at the grating due to fine and/or regular structures. These invalid depth values prevent a reliable sensor operation. A further problem occurs due to bare, that is highly reflective, grating bars that show an increased brightness effect and therefore produce detection problems.

Starting from this, it is the object of the invention to provide a solution that prevents or at least reduces these negative influences from outside the partitions, wherein the partitions should still remain visually transparent.

This object is satisfied by an optoelectronic apparatus having the features of claim 1.

The apparatus for securing a source of danger in a spatial zone comprises at least one sensor that works in the infrared spectrum and that can generate range-resolved data of the spatial zone or with the aid of which range-resolving data can be calculated as well as an evaluation unit that is configured for the evaluation of the data for the detection of objects in a three-dimensional protected space within the spatial zone, wherein the source of danger is additionally at least partly secured by a mechanical partition that is at least very largely permeable to visually visible light. In accordance with the invention, the partition is coated with a layer such that the non-coated partition that is at least partly transparent for the image sensor is/becomes visible for the image sensor in a defined manner through/by means of the layer and is/becomes opaque in the infrared.

If the coated partition is visible for the optoelectronic apparatus, on the one hand, and is opaque, on the other hand, it can no longer occur that objects behind the partition disturb the image sensor in that they dazzle it or in that they absorb the light. At the same time, the layer can be configured such that it remains transparent for the visible light and thus visually transparent.

The optical sensor can also have a plurality of sensor units that monitor a common spatial zone.

The layer is preferably a reflective film that can then be adhered to the partition in a simple manner. Alternatively, the film could also be fastened in a different manner, e.g. electrostatically or firmly bonded or the like.

In this respect, the film can include a proportion of particles retroreflective in the infrared spectrum and a proportion of IR-light absorbing particles. The retroreflective particles ensure a defined visibility and the absorbing particles ensure the opaqueness.

The film is advantageously of a multilayer design having a first visually transparent film layer with IR-retroreflective particles (e.g. microspheres) and a second film layer that is likewise visually transparent, but IR-absorbing (e.g. ITO particles).

Alternatively to a film, the layer can in a simple manner also comprise sprayed on IR-retroreflective particles. This simplifies the application onto the partition.

In a further alternative, retroreflective particles are positioned between two film layers. The particles are thereby largely surrounded by air, whereby particularly favorable refractive index jumps are provided for the retroreflective property of microspheres.

The layer must have a remission or retroreflection sufficient in the IR spectrum in the direction of the sensor. In this context, sufficient means that the wanted signal strength is large enough in comparison with the unwanted signal strength to carry out a signal evaluation. The layer can be adhered to transparent plates of the protective walls or can be hung before metal gratings and is visually transparent.

The particles in the layer are transparent in the visual light spectrum and are remitting in the IR spectrum. The proportion of the remitted IR light and simultaneously of the transmitted visible light can be controlled with the aid of the particle concentration. It applies in this respect that the higher the particle concentration, the higher the proportion of remitted IR light and the smaller the proportion of transmitted visible light. A good particle concentration produces a sufficient proportion of the IR light reflected back to the sensor and a sufficient transparency (of the visible light).

If no disturbing IR signals can occur behind the walls, a small IR transmission of the adapted walls can be dispensed with. In this case, the sensor should detect the protective wall in order e.g. to obtain a quiescent current signal. It is sufficient here to apply only retroreflective particles. They can, as described, either be introduced onto the film or into the film or can be applied directly in the form of a spray (e.g. Albedo 100, InformCare Ltd.) onto the wall elements without film.

The invention will be explained in more detail in the following also with respect to further features and advantages by way of example with reference to embodiments and to the enclosed drawing. The Figures of the drawing show in:

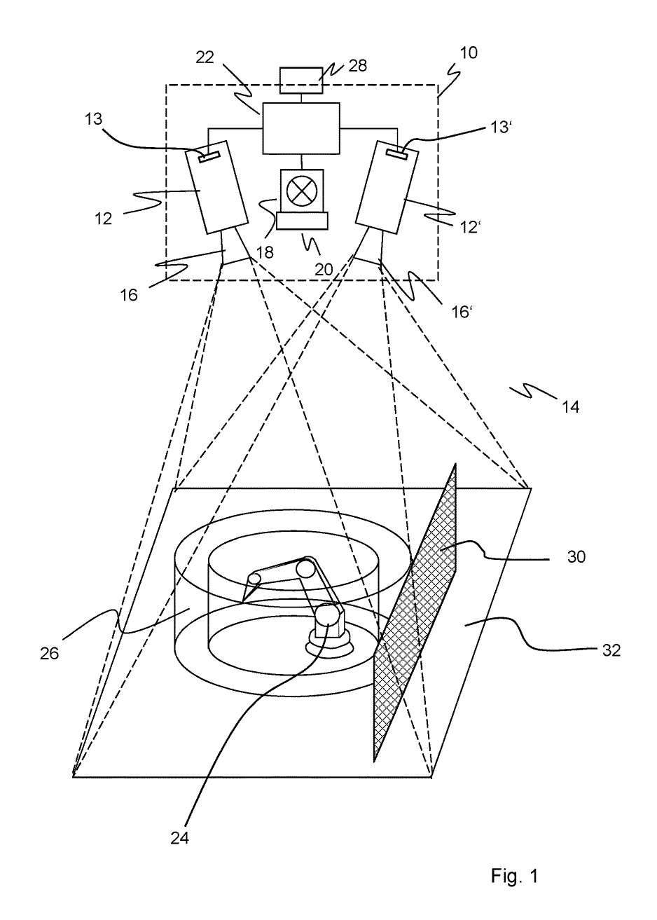

FIG. 1 a schematic three-dimensional representation of an apparatus in accordance with the invention; and

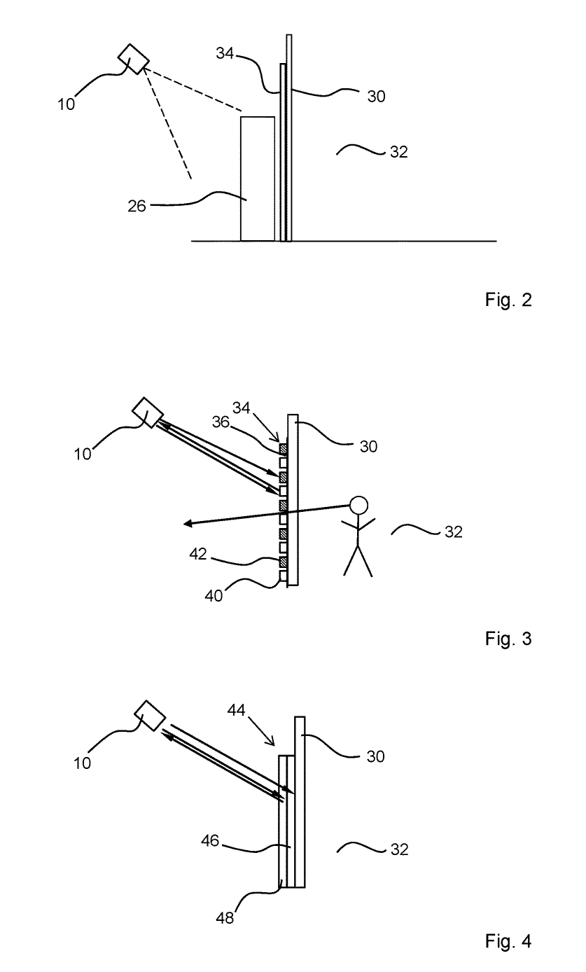

FIGS. 2 to 4 side views of a camera, monitored protected space, partition and object.

FIG. 1 shows in a schematic three-dimensional representation the structure of an embodiment of the apparatus 11 in accordance with the invention on the basis of a three-dimensional stereoscopic camera 10. Two camera modules 12, 12′ are mounted at a known, fixed spacing from one another. Both cameras 12, 12′ each record the image of a monitored zone 14. The cameras 12, 12′ have an objective 16, 16′, only indicated, having an imaging optics. The angle of view of the this optics is shown by dashed lines in FIG. 1, which each form a visual pyramid, and amounts to 45° , for example. An image sensor 13, 13′ is provided in each camera 12, 12′. This image sensor 13, 13′ is a matrix-shaped imaging chip that records a rectangular pixel image and can, for example, be a CCD sensor or a CMOS sensor.

An illumination source 18 is arranged at the center between the two cameras 12, 12′. A laser having a power between 1 and 8 W serves as a light source for the illumination source 18. The laser of the illumination source 18 generates pulses of a length of 1-10 ms. The laser power can also be higher, provided that the protection rating allows it and the higher costs can be accepted. The use of one or more LEDs is alternatively also conceivable.

A diffractive optical element 20 is arranged downstream of the illumination source 18 in the optical axis to generate an illumination pattern in the monitored zone 14. The illumination source 18 generates light of a predefined and known wavelength that is in the infrared range. The diffractive optical element 20 deflects, selectively for the wavelength, the light incident from the illumination source 18 only into specific regions of the monitored zone 14. The arising illumination pattern can be a spot pattern or circular pattern arranged in a regular, that is matrix-like, form.

Different illumination patterns can also be generated using a different diffractive optical element 20. Different pattern generation methods are also conceivable, e.g. by means of a stochastic microlens array. In this respect, any desired pattern can be generated that is helpful and of high contrast for the evaluation, e.g. a linear pattern, a checkerboard pattern or a grid pattern. In principle, a mask can also be used instead of a diffractive optical element 20. This is, however, less advantageous since a portion of the light energy scattered in is lost in the mask. Alternatively to a regular pattern, an irregular pattern can be provided that can therefore not be cast back onto itself in any region by geometrical operations such as displacement, reflection or rotation. A conclusion can then be drawn from the pattern zone on the position in space, whereas a regular pattern does not allow this due to ambiguities.

A control and evaluation unit 22 is connected to the two cameras 12, 12′ and to the illumination source 18. The unit 22 switches the light pulses of the illumination source 18 and receives image signals from the two cameras 12, 12′. The control and evaluation unit 22 furthermore calculates three-dimensional image data of the spatial zone 14 with the aid of a stereoscopic disparity estimate.

A robot arm 24, which represents a source of danger, is located in the spatial zone 14 monitored by the apparatus 11. When the robot 24 moves, no unauthorized object and in particular no body part of an operator may be located in its radius of movement. A virtual three-dimensional protected space 26 is therefore laid around the robot arm 24. The evaluation unit 22 evaluates the image data in this protected space 26 to recognize unauthorized object intrusions.

If the evaluation unit 22 recognizes an unauthorized intrusion into the protected zone, a warning is output via a warning or shutdown device 28 or the source of danger is secured, that is the robot arm 24 is stopped in the example shown. In this respect, it depends on the application whether a warning is sufficient or a two-stage security is provided in which a warning is initially given and a shutdown is only made on a continued object intrusion or an even deeper penetration.

The safety sensor 10 is configured as fail-safe for applications in safety engineering. This inter alia means that the safety sensor 10 can test itself in cycles under the required response time and that the output to the warning and shutdown device and the warning and shutdown device 28 is designed as fail-safe, for example as dual channel. The control and evaluation unit 22 is equally also fail-safe, that is it evaluates over dual channels and/or uses algorithms that can test themselves.

Instead of the shown stereoscopic method, the invention also comprises further three-dimensional camera systems, for instance a time-of-flight camera that transmits light pulses or modulated light and draws conclusions on distances from the time of flight of light or actively triangulating cameras that utilize distortions in the structure of the illumination pattern or the position of parts of the illumination pattern in the recorded image for the calculation of distance data. In principle, the use of light field cameras would also be possible.

In addition to this securing with the virtual protected space 26, the apparatus has a mechanical partition 30 that mechanically separates a freely accessible outer zone 32 from the protected zone 26. The partition 30 is visually transparent, that is permeable in the visible light, so that an operator can observe the robot 24 from the outer zone 32. The partition 30 can e.g. comprise acrylic glass or a metal grating for this purpose.

In accordance with the invention, the partition 30 is coated with a layer 34 (FIGS. 2 and 3) such that the non-coated partition 30 that is at least partly transparent for the camera 10 is visible for the camera in a defined manner through the layer 34 and is opaque. Objects that are located in the freely accessible zone 32 can then no longer disturb the camera 10, on the one hand, and it is ensured, on the other hand, that the camera 10 can always “see” the partition 30 as a full-area (in contrast with gratings), opaque wall.

The layer 34 in an embodiment of the invention comprises a film 36 that has a sufficient remission or retroflection in the direction of the camera 10 in the IR spectrum. In this context, sufficient means that the wanted signal strength is large enough in comparison with the unwanted signal strength to carry out a signal evaluation. The film 36 can be adhered to the partition 30 or can be hung when the partition 30 is configured as a metal grating. The film 36 is transparent visually, that is in the visible spectral range.

So that the film does not reflect the IR light, it includes a functional particle mixture comprising a proportion of IR-retroreflective particles 40 (e.g. microspheres) and a proportion of IR-absorbing and simultaneously visually transparent particles 42 (e.g. ITO particles). The particles 40, 42 can either be applied onto the film 36 or can be admixed to a melt for the film manufacture. The particles 40 have the properties that they are transparent in the visual light spectrum and are remitting in the IR spectrum.

The proportion of the remitted IR light and simultaneously of the transmitted visible light can be controlled with the aid of the particle concentration. It applies in this respect that the higher the particle concentration, the higher the proportion of remitted IR light and the smaller the proportion of transmitted visible light. A good particle concentration produces a sufficient proportion of the IR light reflected back to the light source and a sufficient transparency (of the visible light). It is sensible to provide different films to be able to take account of the lighting conditions on site.

In another embodiment of the film 36 (FIG. 4), the latter can be formed as a multilayer film 44 and can have a layer 46 having a visually transparent and IR-absorbing property on which a further layer 48 is applied that is visually transparent and includes IR-retroreflective particles.

1. An optoelectronic apparatus for securing a source of danger in a spatial zone, the optoelectronic apparatus having
at least one sensor that works in the infrared spectrum and that can generate range-resolved data of the spatial zone, as well as
an evaluation unit that is configured for the evaluation of the data for the detection of objects in a three-dimensional protected space within the spatial zone,
wherein the source of danger is additionally at least partly secured by a mechanical partition that is at least very largely permeable for visually visible light, and
wherein the partition is coated with a layer in such a way that the non-coated partition that is at least partly transparent for the sensor becomes visible for the sensor in a defined manner and becomes opaque in the infrared spectrum by means of the layer.

2. The apparatus in accordance with claim 1, wherein the layer is a reflective film.

3. The apparatus in accordance with claim 2, wherein the reflective film includes a proportion of particles that are retroreflective in the infrared spectrum and a proportion of light-absorbing particles.

4. The apparatus in accordance with claim 2, wherein the reflective film is of a multilayer structure and has a first optically transparent film layer having IR-retroreflective particles and has a second film layer that is likewise optically transparent, but IR absorbing.

5. The apparatus in accordance with claim 2, wherein the reflective film is of a multilayer structure, with particles that are retroreflective in the infrared spectrum being held between two film layers.

6. The apparatus in accordance with claim 1, wherein the layer comprises sprayed on IR-retroreflective particles.
